(19) United States
(12) Patent Application Publication
(10) Pub. No.: US 2018/0343251 A1
(43) Pub. Date: Nov. 29, 2018

(54) PROCESSING METHOD AND APPARATUS FOR REMOTE ASSISTANCE

(71) Applicants: QINGDAO HISENSE ELECTRONICS CO., LTD., Qingdao (CN); Jamdeo Canada Ltd., Oakville, CA (US)

(72) Inventors: Terry VOTH, Oakville (CA); Mikhail SHOYKHER, Oakville (CA); Tong CHEN, Oakville (CA)

(21) Appl. No.: 15/742,335

(22) PCT Filed: Nov. 20, 2017
(86) PCT No.: PCT/CN2017/111942

§ 371 Date: Jan. 5, 2018

(30) Foreign Application Priority Data
Nov. 16, 2017 (CN) 201711139725.9

(51) Int. Cl. H04L 29/06; H04L 29/08; G06F 9/451; H04L 9/32; H04L 9/08

(52) U.S. Cl. CPC H04L 63/0876; H04L 67/025; G06F 9/452; H04L 63/126; H04L 9/3228; H04L 9/0861; H04L 67/42; H04L 63/10

(57) ABSTRACT

The present disclosure provides a processing method and apparatus for remote assistance; after receiving a startup instruction, a client sends a request for a verification code to a server; the server generates and returns the verification code to the client; and the client generates and stores a check code according to the verification code and a random code generated locally by the client after receiving the startup instruction. Since the check code generated by the client is generated according to the verification code randomly generated by the server and the random code randomly generated at the local, the uniqueness of the check code is ensured.

This application is a National Stage of International Application No. PCT/CN2017/111942, filed Nov. 20, 2017, which claims priority to Chinese Patent Application No. 201711139725.9, filed Nov. 16, 2017, both of which are hereby incorporated by reference in their entireties.

### FIELD

This disclosure relates to the field of communications, and particularly to a processing method and apparatus for remote assistance.

### BACKGROUND

At present, with the development of internet technology, the remote assistance technology will be used in more and more fields. The remote assistance is a technology where one computer device remotely controls another computer device via the network.

### SUMMARY

An embodiment of the present disclosure provides a processing method for remote assistance, including: receiving, by a server, a request from a client for a verification code; generating, by the server, the verification code according to the request; and returning, by the server, the verification code to the client such that the client combines the verification code with a random code generated locally by the client to generate a check code to be displayed to a user.

An embodiment of the present disclosure provides another processing method for remote assistance, including: sending, by a client, a request for a verification code to a server after receiving a startup instruction; receiving, by the client, the verification code returned by the server; and generating and storing, by the client, a check code according to the verification code and a random code generated locally by the client after receiving the startup instruction.

An embodiment of the present disclosure provides a server, including a memory and a processor, wherein the memory stores a computer program, and execution of the computer program by the processor causes the processor to: receive a request from a client for a verification code; generate the verification code according to the request; and return the verification code to the client such that the client combines the verification code with a random code generated locally by the client to generate a check code to be displayed to a user.

An embodiment of the present disclosure provides a machine readable non-transitory storage medium, including program codes; the program codes are configured to enable computing equipment to execute operations of a processing method for remote assistance which is implemented at a client side according to the embodiment of the present disclosure when the program codes run on the computing equipment.

An embodiment of the present disclosure provides a machine readable non-transitory storage medium, including program codes; the program codes are configured to enable computing equipment to execute operations of a processing method for remote assistance which is implemented at a server side according to the embodiment of the present disclosure when the program codes run on the computing equipment.

### BRIEF DESCRIPTION OF THE DRAWINGS

FIG. 1 is a first schematic flow chart of a processing method for remote assistance which is implemented at a server side according to an embodiment of the present disclosure;

FIG. 2 is a second schematic flow chart of a processing method for remote assistance which is implemented at a server side according to an embodiment of the present disclosure;

FIG. 3 is a third schematic flow chart of a processing method for remote assistance which is implemented at a server side according to an embodiment of the present disclosure;

FIG. 4 is a first schematic flow chart of a processing method for remote assistance which is implemented at a client side according to an embodiment of the present disclosure;

FIG. 5 is a second schematic flow chart of a processing method for remote assistance which is implemented at a client side according to an embodiment of the present disclosure;

FIG. 6 is a third schematic flow chart of a processing method for remote assistance which is implemented at a client side according to an embodiment of the present disclosure;

FIG. 7 is a schematic complete interaction diagram of a processing method for remote assistance according to an embodiment of the present disclosure;

FIG. 8 is a schematic structural diagram of a server according to an embodiment of the present disclosure;

FIG. 9 is a schematic structural diagram of a terminal according to an embodiment of the present disclosure;

FIG. 10 is another schematic structural diagram of a server according to an embodiment of the present disclosure;

FIG. 11 is a schematic structural diagram of a client according to an embodiment of the present disclosure.

### DETAILED DESCRIPTION OF THE EMBODIMENTS

In order to make the objects, the technical solutions and the advantages of this disclosure more apparent, the disclosure will be further described in details with reference to the drawings. Apparently the described embodiments are only a part but not all of the embodiments of this disclosure. Based upon the embodiments of this disclosure here, all of other embodiments derived by those ordinarily skilled in the art without any inventive effort shall come into the scope of this disclosure.

First, a brief description on client and application will be given.

A client can be regarded as an application, and refers to a program responsible to a server and used for providing local services to a user. Except for some applications that run locally only, clients are generally installed on ordinary client computers to work together with servers. After the development of the Internet, the more commonly used clients include web browsers for the World Wide Web, e-mail clients for sending and receiving e-mails, and client software for instant messaging, etc. For this kind of applications, appropriate servers and service programs are needed in a network to provide corresponding services, such as database services, e-mail services, etc.; therefore, it is needed to establish a specific communication connection at a client computer side and a server side to ensure a normal operation of an application.

With the development of computer networks, the form of connections changes gradually. So far, the two mainstream network connection modes are C/S and B/S modes, i.e., Client/Server and Browser/Server. Therefore, the client should be more understood under the C/S mode. That is, by writing some programs to a client computer to ensure that even if a server has a failure or is under maintenance, the client can still work offline under the premise of ensuring work. While the applications may be working in the C/S mode or in the B/S mode.

A remote assistance solution typically consists of a client running on a device (e.g., a TV) owned by an end user and located remotely from the manufacturer of the device, and a server that acts as a contact point for the client to communicate with.

Whether it is a device failure caused by a software issue within the device itself or by a usage issue due to the user, the user can start the client for remote assistance.

When the client is started by the user, it communicates with the server. The application (e.g., a client or a browser) used by a Customer Service Representative (CRS) working for the manufacturer of the device is able to communicate with the server as well and, through the server, indirectly communicate with the client. In this way, the application used by the CRS is able to communicate with the client running on a remote device to download information from the device or upload information to the device.

Generally, the server and the client communicate with each other through the public internet. The security of the communication is easily threatened, and access to the device on which the client is running by the unauthorized access sources easily occurs, resulting in a safety loophole.

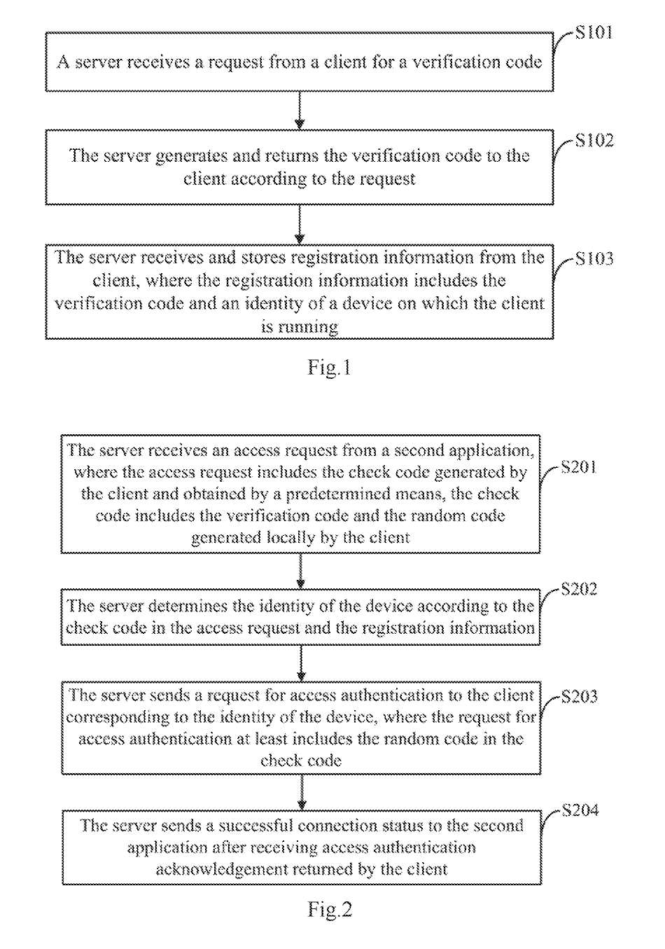

An embodiment of the present disclosure provides a processing method for remote assistance which is implemented at a server side, as illustrated in FIG. 1, including the following operations.

S101: a server receives a request from a client for a verification code.

S102: the server generates and returns the verification code to the client according to the request such that the client combines the verification code with a random code generated locally by the client to generate a check code to be displayed to a user.

In some embodiments, a safe communication is established between the server and the client through the above operations S101 to S102. Particularly, since the server generates verification codes randomly each time, and verification codes generated by the server are different with each other within the validity period of the verification codes, to ensure the uniqueness of each verification code, thus the uniqueness of a check code generated by the client according to each verification code is ensured.

Optionally, in some embodiments, as illustrated in FIG. 1, the method further includes the following operation.

S103: the server receives and stores registration information from the client, where the registration information includes the verification code and an identity of a device on which the client is running.

In some embodiments, since the server only stores the verification code which is a part of the check code, the possibility that an unauthorized access source operates the client after learning the check code through the server is completely eradicated and the security of the communication between the server and the client is ensured.

Optionally, in some embodiments, as illustrated in FIG. 2, the method further includes the following operations.

S201: the server receives an access request from a second application, where the access request includes the check code generated by the client and obtained by a predetermined means, the check code includes the verification code and the random code generated locally by the client; the predetermined means is by phone and the like.

S202: the server determines the identity of the device according to the check code in the access request and the registration information.

S203: the server sends a request for access authentication to the client corresponding to the identity of the device, where the request for access authentication at least includes the random code in the check code; particularly, the request for access authentication includes the whole check code, or only includes the random code to reduce the amount of transmitted data, which is not limited herein.

S204: the server sends a successful connection status to the second application after receiving access authentication acknowledgement returned by the client.

In some embodiments, a communication connection channel between the second application used by a customer service representative (called customer service for short) and the client is established through the above operations S201 to S204.

After generating the check code according to the verification code and the locally generated random code, the client displays the check code according to a predetermined display form via a terminal (for example, a smart television or the like), where the predetermined display form includes font size, color, etc. for highlighting the check code. After the check code is informed by the user to the customer service by telephone and the like, the customer service performs access authentication with the server through an application installed on his or her terminal (e.g., a device such as a PC or a tablet); the server determines the identity of the device through the verification code in the check code and the locally stored registration information of the client and then communicates with the client corresponding to the identity of the device, the client at least verifies the random code in the check code to establish a secure communication connection channel with the application used by the customer service after passing the verification.

Particularly, the second application is implemented as a browser which is used by the CSR to log in an interface, or is implemented as a separate client which is running on the CSR's computer, which is not limited herein.

Optionally, in the processing method above according to the embodiment of the present disclosure, the verification code includes a combination of numbers, a combination of characters, or a combination of numbers and characters. The random code includes a combination of numbers, a combination of characters, or a combination of numbers and characters. The number of digits of a combination of numbers or characters may be small so that the user can read the check code and inform the CSR the check code conveniently.

For example, the verification code generated by the server may be 123, and the random code generated by the client may be 456. The client can combine the verification code and the random code according to a set rule to obtain a check code. For example, the check code finally generated by the client may be 123456 or 456123, or the like.

Particularly, when the verification code, the random code and the check code are all combinations of numbers, it is beneficial for the client to transmit the check code to the user and is beneficial for the user to inform the customer service by phone or the like. Of course, in actual operation, the verification code, the random code and the check code may also be characters, symbols or numbers or may be combinations of characters, symbols and numbers, which are not limited herein.

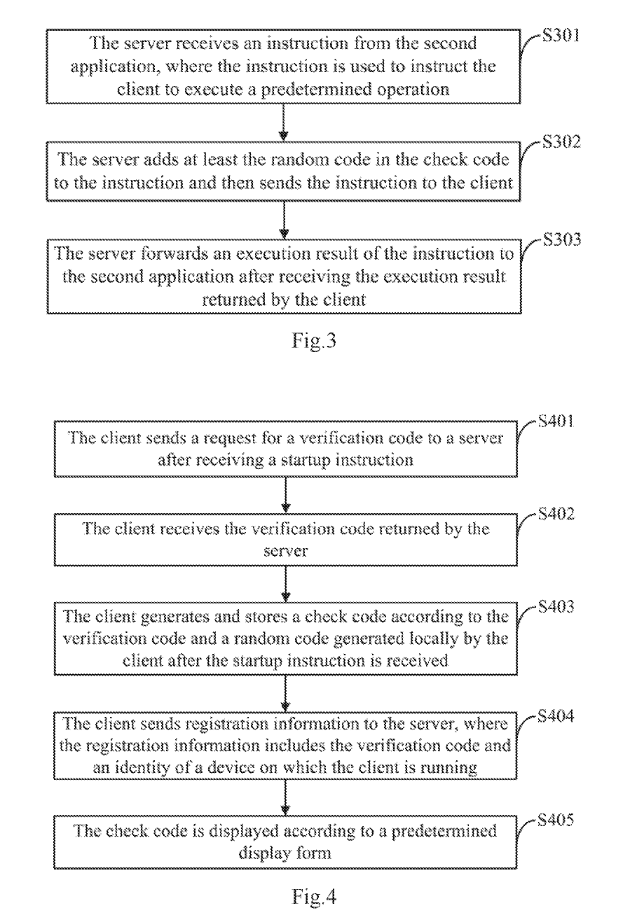

Optionally, in the processing method above according to the embodiment of the present disclosure, as illustrated in FIG. 3, the method further includes the following operations.

S301: the server receives an instruction from the second application, where the instruction is used to instruct the client to execute a predetermined operation; where the predetermined operation is an operation such as restarting, updating, or the like.

S302: the server adds at least the random code in the check code to the instruction and then sends the instruction to the client; particularly, the whole check code is added to the instruction, or only the random code is added to the instruction to reduce the amount of transmitted data, which is not limited herein.

S303: the server forwards an execution result of the instruction to the second application after receiving the execution result returned by the client.

Particularly, in the processing method above according to the embodiment of the present disclosure, after a secure communication connection channel is established between the second application used by the customer service and the client, the remote control of the second application used by the customer service to the client is implemented through the above operations S301 to S303.

Particularly, after the customer service sends an instruction to the server through the second application, where the instruction is used to instruct the client to perform a predetermined operation, such as restarting, updating, or the like, the server will add the check code to the instruction and then send the instruction to the client; after successfully verifying the random code, the client executes the corresponding instruction to implement the remote control of the client by the customer service. Particularly, remote control includes but is not limited to instructions for restarting and repairing the client and the like.

Based on the same inventive concept, an embodiment of the present disclosure further provides a processing method for remote assistance which is implemented at a client side. As illustrated in FIG. 4, the method includes the following operations.

S401: the client sends a request for a verification code to a server after receiving a startup instruction.

S402: the client receives the verification code returned by the server.

S403: the client generates and stores a check code according to the verification code and a random code generated locally by the client after the startup instruction is received.

Particularly, in the processing method above according to the embodiment of the present disclosure, secure communication between the server and the client is established through the above operations S401 to S403. Particularly, since the check code generated by the client is generated according to the verification code randomly generated by the server and the random code randomly generated at the local, the uniqueness of the check code is ensured.

Optionally, in some embodiments, as illustrated in FIG. 4, the method further includes the following operation.

S404: the client sends registration information to the server, where the registration information includes the verification code and an identity of a device on which the client is running.

Since the random code generated locally by the client is stored locally only and is not send to the server. That is, only the client stores the whole check code, and the server only stores the verification code which is a part of the check code; therefore, the possibility that an unauthorized access source operates the client after learning the check code through the server is completely eradicated and the security of communication between the server and the client is ensured.

Optionally, in the processing method above according to the embodiment of the present disclosure, after the client receives the startup instruction in operation S401, the client may further execute the following operation: the client generates the random code locally. That is, after receiving a startup instruction, the client first generates a random code locally, and then sends a request for a verification code to the server. Certainly, in an actual operation, after sending the request for the verification code to the server, or after receiving the verification code returned by the server, the client executes the operation of generating the random code locally, which is not limited herein.

Optionally, in the processing method above according to the embodiment of the present disclosure, the verification code includes a combination of numbers, a combination of characters, or a combination of numbers and characters. The random code includes a combination of numbers, a combination of characters, or a combination of numbers and characters. The number of digits of a combination of numbers or characters may be small so that the user can read the check code and inform the CSR the check code conveniently.

For example, the verification code generated by the server may be 123, and the random code generated by the client may be 456. The client can combine the verification code and the random code according to a set rule to obtain a check code. For example, the check code finally generated by the client may be 123456 or 456123, or the like.

Particularly, when the verification code, the random code and the check code are all combinations of numbers, it is beneficial for the client to transmit the check code to the user and is beneficial for the user to inform the customer service by phone or the like. Certainly, in actual operation, the verification code, the random code and the check code may also be characters, symbols or numbers or may be combinations of characters, symbols and numbers, which are not limited herein.

Optionally, in the processing method above according to the embodiment of the present disclosure, as illustrated in FIG. 4, the method further includes the following operation.

S405: the check code is displayed according to a predetermined display form. For example, the check code is displayed in a display screen to inform the user the generated check code.

Optionally, in the processing method above according to the embodiment of the present disclosure, as illustrated in FIG. 5, the method further includes the following operations.

S501: the client receives a request for access authentication from the server, where the request for access authentication at least includes the random code in the check code; particularly, the request for access authentication includes a whole check code, or only includes a random code to reduce the amount of transmitted data, which is not limited herein.

S502: the client at least verifies the random code included in the request for access authentication according to the check code stored locally by the client; particularly, when the request for access authentication includes the whole check code, the client may only verify the random code included in the request to reduce the amount of computation, or may verify the whole check code, which is not limited herein; when the request for access authentication only includes the random code, the client may only verify the random code.

S503: the client returns access authentication acknowledgement to the server after verifying successfully.

Particularly, in the processing method above according to the embodiment of the present disclosure, a communication connection channel between the second application used by the customer service representative (called customer service for short) and the client is established through the above operations S501 to S503.

Particularly, after generating a check code according to the verification code, the client displays the check code to the user. After the check code is informed by the user to the customer service by telephone and the like, the customer service performs access authentication with the server through the second application; the server determines the identity of a device through the verification code in the check code and the locally stored registration information and then communicates with the client corresponding to the identity of the device. The client at least verifies the random code included in the request for access authentication from the server according to the check code stored locally by the client, and establishes a secure communication connection channel with the second application used by the customer service through the server after the verification is successful.

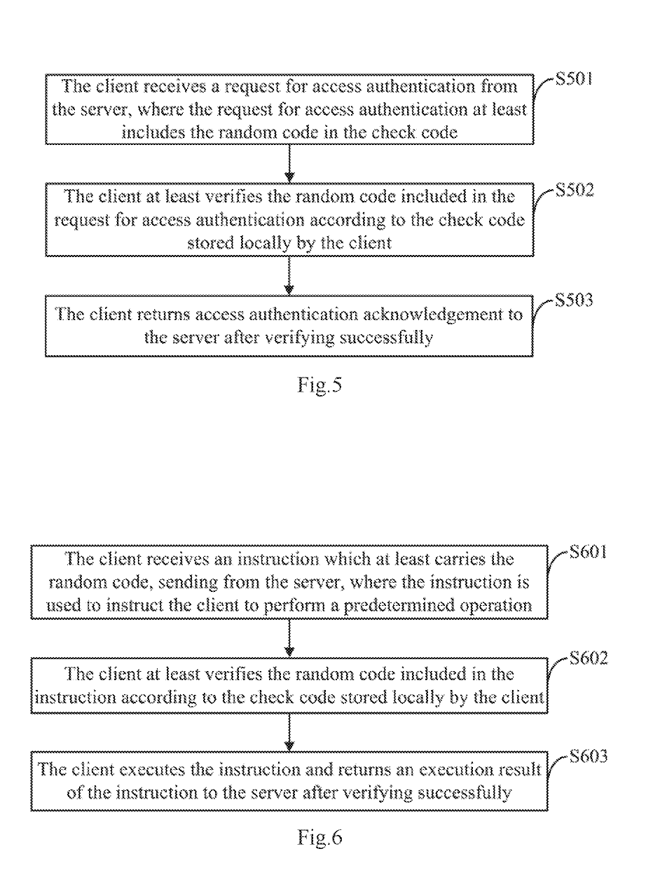

Optionally, in the processing method above according to the embodiment of the present disclosure, as illustrated in FIG. 6, the method further includes the following operations.

S601: the client receives an instruction which at least carries the random code, sending from the server, where the instruction is used to instruct the client to perform a predetermined operation, such as restarting, updating or the like; particularly, the instruction carries a whole check code, or only carries a random code, so as to reduce the amount of transmitted data, which is not limited herein.

S602: the client at least verifies the random code included in the instruction according to the check code stored locally by the client; particularly, when the instruction includes the whole check code, the client may only verify the random code included in the instruction to reduce the amount of computation, or may verify the whole check code, which is not limited herein; when the instruction only includes the random code, the client may only verify the random code.

S603: the client executes the instruction and returns an execution result of the instruction to the server after verifying successfully.

Particularly, in the processing method above according to the embodiment of the present disclosure, after the secure communication connection channel between the client and the second application used by the customer service is established, the remote control of the client by the second application used by the customer service is implemented through the above operations S601 to S603.

Particularly, after the customer service sends an instruction to the server through the second application, the server adds at least the random code to the instruction and then sends the instruction to the client, and the client executes a corresponding instruction to implement the remote control of the client by the customer service after the verification is successful. Particularly, remote control includes but is not limited to instructions for restarting and repairing the client and the like.

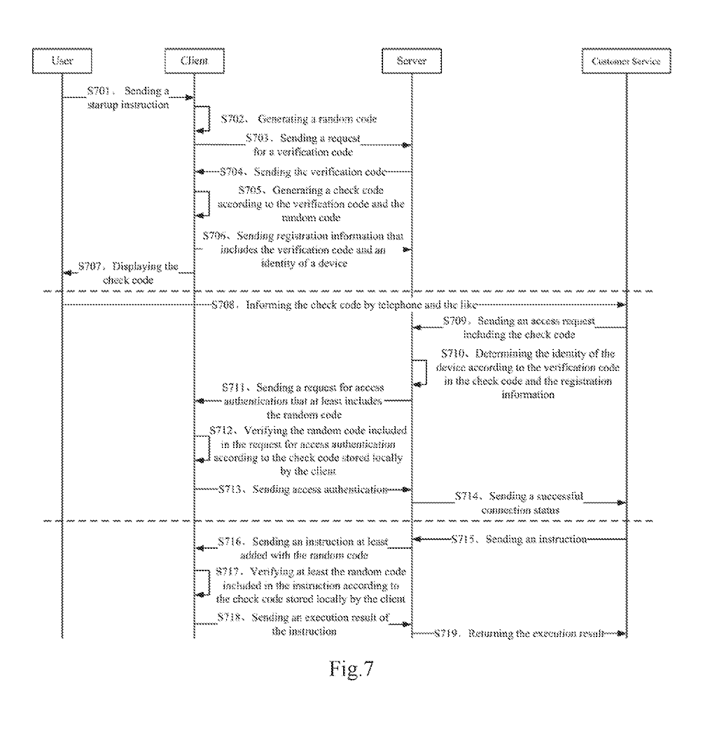

Particularly, the complete interaction process of the processing method for remote assistance according to the embodiment of the present disclosure, as illustrated in FIG. 7, includes the following operations.

S701: a startup instruction from a user is received by a client.

S702: the client generates a random code locally.

S703: the client sends a request for a verification code to a server.

S704: the server sends the verification code generated randomly to the client.

S705: the client generates a check code according to the verification code and the random code.

S706: the client sends to the server registration information that includes the verification code and an identity of a device on which the client is running.

S707: the client displays the check code to the user.

S708: the check code is informed by the user to a second application used by a customer service representative (called customer service for short) by telephone and the like.

S709: the second application used by the customer service sends an access request including the check code to the server.

S710: the server determines the identity of the device according to the verification code in the check code and the registration information.

S711: the server sends a request for access authentication to the client corresponding to the identity of the device, where the request for access authentication at least includes the random code; particularly, the request for access authentication includes the whole check code, or only includes the random code to reduce the amount of transmitted data, which is not limited herein.

S712: the client at least verifies the random code included in the request for access authentication according to the check code stored locally by the client; particularly, when the request for access authentication includes the whole check code, the client may only verify the random code included in the request to reduce the amount of computation, or may verify the whole check code, which is not limited herein; when the request for access authentication only includes the random code, the client may only verify the random code.

S713: the client sends access authentication acknowledgement to the server after verifying successfully.

S714: the server sends a successful connection status to the second application.

S715: the second application sends an instruction to the server.

S716: The server sends to the client an instruction at least added with the random code; particularly, the whole check code is added to the instruction, or only the random code is added to the instruction to reduce the amount of transmitted data, which is not limited herein.

S717: the client at least verifies the random code included in the instruction according to the check code stored locally by the client; particularly, when the instruction includes the whole check code, the client may only verify the random code included in the instruction to reduce the amount of computation, or may verify the whole check code, which is not limited herein; when the instruction only includes the random code, the client may only verify the random code.

S718: the client executes the instruction and sends an execution result of the instruction to the server after verifying successfully.

S719: the server returns the execution result to the second application.

Particularly, secure communication is established between the client and the server through the above operations S701 to S707. A secure communication connection channel is established between the second application used by the customer service and the client through the above operations S708 to S714. The remote control of the client by the second application used by the customer service is implemented through the above operations S715 to S719.

Particularly, the processing method above according to the embodiment of the present disclosure may be applied to the remote assistance control for a smart television, where the client is installed on the smart television, and the server is a cloud server.

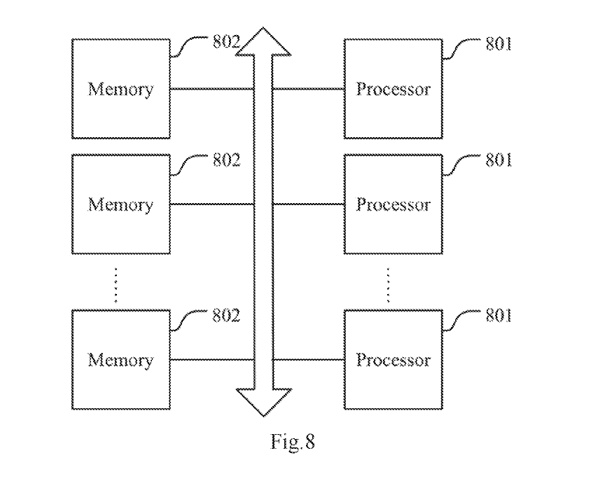

Based on the same inventive concept, an embodiment of the present disclosure further provides a server, as illustrated in FIG. 8, which particularly includes: a processor 801 and a memory 802, where the memory 802 stores a computer program, and execution of the computer program by the processor 801 causes the processor 801 to: receive a request from a client for a verification code; randomly generate the verification code according to the request; and return the verification code to the client such that the client combines the verification code with a random code generated locally by the client to generate a check code to be displayed to a user.

Optionally, in the server above according to the embodiment of the present disclosure, the execution of the computer program by the processor 801 further causes the processor 801 to: receive and store registration information from the client, where the registration information includes the verification code and an identity of a device on which the client is running.

Optionally, in the server above according to the embodiment of the present disclosure, the execution of the computer program by the processor 801 further causes the processor 801 to: receive an access request from a second application, where the access request includes the check code generated by the client and obtained by a predetermined means, and the check code includes the verification code and the random code generated locally by the client; determine the identity of the device according to the check code in the access request and the registration information; send a request for access authentication to the client corresponding to the identity of the device, where the request for access authentication at least includes the random code in the check code; and send a successful connection status to the second application after receiving access authentication acknowledgement returned by the client.

Optionally, in the server above according to the embodiment of the present disclosure, the execution of the computer program by the processor 801 further causes the processor 801 to: receive an instruction from the second application, where the instruction is used to instruct the client to execute a predetermined operation; at least add the random code in the check code to the instruction and then send the instruction to the client; and forward an execution result of the instruction to the second application after receiving the execution result returned by the client.

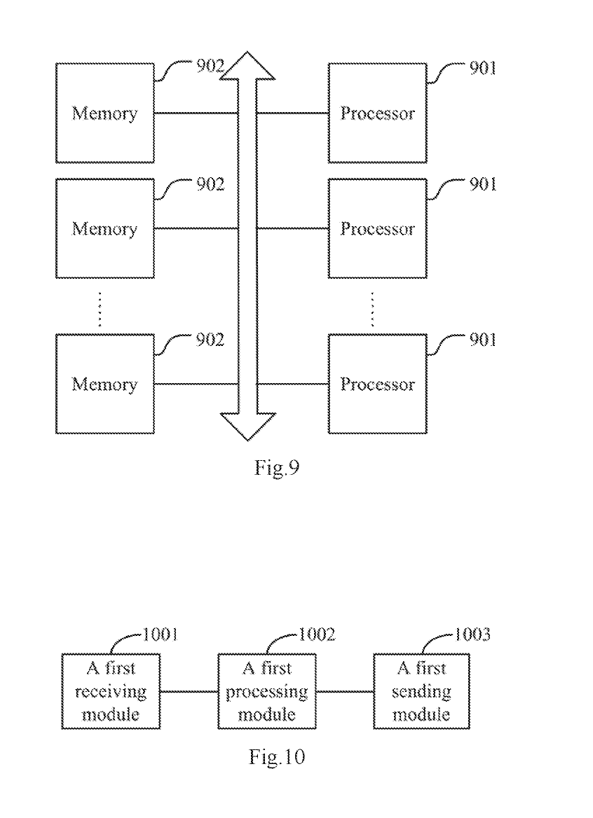

Based on the same inventive concept, an embodiment of the present disclosure further provides a terminal, as illustrated in FIG. 9, which particularly includes: a processor 901 and a memory 902, where the memory 902 stores a computer program, and execution of the computer program by the processor 901 causes the processor 901 to: send a request for a verification code to a server after receiving a startup instruction; receive the verification code returned by the server; and generate and store a check code according to the verification code and a random code generated locally by the client after receiving the startup instruction.

Optionally, in the terminal above according to the embodiment of the present disclosure, the execution of the computer program by the processor 901 further causes the processor 901 to: send registration information to the server, where the registration information includes the verification code and an identity of a device on which the client is running.

Optionally, in the terminal above according to the embodiment of the present disclosure, the execution of the computer program by the processor 901 further causes the processor 901 to: generate the random code locally after the client receives the startup instruction.

Optionally, in the terminal above according to the embodiment of the present disclosure, the execution of the computer program by the processor 901 further causes the processor 901 to: display the check code according to a predetermined display form.

Optionally, in the terminal above according to the embodiment of the present disclosure, the execution of the computer program by the processor 901 further causes the processor 901 to: receive a request for access authentication from the server, where the request for access authentication at least includes the random code in the check code; verify at least the random code included in the request for access authentication according to the check code stored locally by the client; and return access authentication acknowledgement to the server after verifying successfully.

Optionally, in the terminal above according to the embodiment of the present disclosure, the execution of the computer program by the processor 901 further causes the processor 901 to: receive an instruction which at least carries a random code, sending from the server, where the instruction is used to instruct the client to execute a predetermined operation; verify at least the random code included in the instruction according to the check code stored locally by the client; and execute the instruction and return an execution result of the instruction to the server after verifying successfully.

Based on the same inventive concept, an embodiment of the present disclosure further provides another server, as illustrated in FIG. 10, including: a first receiving module 1001, configured to receive a request from a client for a verification code; a first processing module 1002, configured to generate the verification code according to the request; and a first sending module 1003, configured to return the verification code to the client.

Optionally, in the server above according to the embodiment of the present disclosure, the first receiving module 1001 is further configured to receive and store registration information from the client, where the registration information includes the verification code and an identity of a device on which the client is running.

Optionally, in the server above according to the embodiment of the present disclosure, the first receiving module 1001 is further configured to receive an access request from a second application, where the access request includes a check code generated by the client and obtained by a predetermined means, and the check code includes the verification code and a random code generated locally by the client; the first processing module 1002 is further configured to determine the identity of the device according to the check code in the access request and the registration information; the first sending module 1003 is further configured to send a request for access authentication to the client corresponding to the identity of the device, where the request for access authentication at least includes the random code in the check code; the first receiving module 1001 is further configured to receive access authentication acknowledgement returned by the client; the first sending module 1003 is further configured to send a successful connection status to the second application after the first receiving module 1001 receives the access authentication acknowledgement returned by the client.

Optionally, in the server above according to the embodiment of the present disclosure, the first receiving module 1001 is further configured to receive an instruction from the second application, where the instruction is used to instruct the client to execute a predetermined operation; the first sending module 1003 is further configured to at least add the random code in the check code to the instruction and then send the instruction to the client; the first receiving module 1001 is further configured to receive an execution result of the instruction returned by the client; and the first sending module 1003 is further configured to forward the execution result to the second application after the first receiving module 1001 receives the execution result returned by the client.

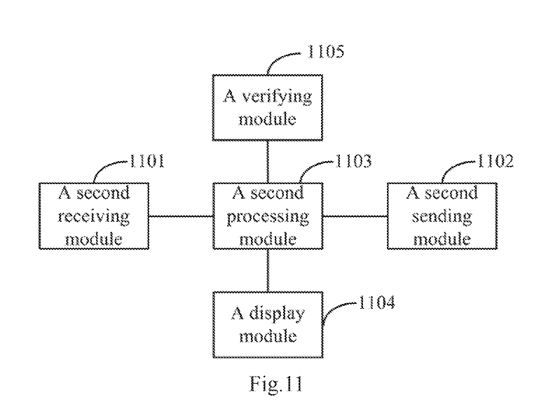

Based on the same inventive concept, an embodiment of the present disclosure further provides a client, as illustrated in FIG. 11, including: a second receiving module 1101, configured to receive a startup instruction; a second sending module 1102, configured to send a request for a verification code to a server after the second receiving module 1101 receives the startup instruction; the second receiving module 1101, further configured to receive the verification code returned by the server; and a second processing module 1103, configured to generate and store a check code according to the verification code and a random code generated locally by the client after receiving the startup instruction.

Optionally, in the client above according to the embodiment of the present disclosure, the second sending module 1102 is further configured to send registration information to the server, where the registration information includes the verification code and an identity of a device on which the client is running.

Optionally, in the client above according to the embodiment of the present disclosure, the second processing module 1103 is further configured to generate the random code locally after the second receiving module 1101 receives the startup instruction.

Optionally, the client above according to the embodiment of the present disclosure, as illustrated in FIG. 11, may further include: a display module 1104, configured to display the check code according to a predetermined display form.

Optionally, the client above according to the embodiment of the present disclosure, as illustrated in FIG. 11, may further include: a verifying module 1105; the second receiving module 1101 is further configured to receive a request for access authentication from the server, where the request for access authentication at least includes the random code in the check code; the verifying module 1105 is configured to at least verify the random code included in the request for access authentication according to the check code stored locally by the client; and the second sending module 1101 is further configured to return access authentication acknowledgement to the server after the verification of the verifying module 1105 is successful.

Optionally, in the client above according to the embodiment of the present disclosure, the second receiving module 1101 is further configured to receive an instruction which at least carries the random code, sending from the server, where the instruction is used to instruct the client to execute a predetermined operation; the verifying module 1105 is further configured to at least verify the random code included in the instruction according to the check code stored locally by the client; the second processing module 1103 is further configured to execute the instruction after verifying successfully; the second sending module 1102 is further configured to return an execution result of the instruction to the server.

Optionally, various aspects of the processing method for remote assistance according to the embodiment of the present disclosure may also be implemented in the form of a program product, which includes program codes; when running on computing equipment, the program codes are configured to enable the computing equipment, to execute operations of the processing method according to various exemplary embodiments of the present disclosure described in this description.

The program product may be implemented with any combination of one or more readable mediums. A readable medium may be a readable signal medium or a readable storage medium. A readable storage medium may be, for example, but not limited to, an electrical, magnetic, optical, electromagnetic, infrared, or semiconductor system, apparatus, or device, or any combination thereof. A more particular example of a readable storage medium (non-exhaustive list) includes: an electrical connection having one or more wires, a portable disk, a hard disk, a random access memory (RAM), a read only memory (ROM), an erasable programmable read-only memory (EPROM or flash memory), optical fiber, a portable compact disk read-only memory (CD-ROM), an optical storage device, a magnetic storage device, or any suitable combination thereof.

The program product for remote assistance according to the embodiment of the present disclosure may be implemented with a portable compact disk read-only memory (CD-ROM) and include program codes and may be run on a server device. However, the program product of the present disclosure is not limited thereto, and a readable storage medium herein may be any tangible medium that contains or stores a program that can be used by or in connection with an information transmission apparatus or device.

The readable signal medium may include data signals propagating in the baseband or as part of a carrier and carries readable program codes therein. The data signals propagating in this way may take many forms, including but not limited to electromagnetic signals, optical signals, or any suitable combination of the foregoing. The readable signal medium may also be any readable medium other than a readable storage medium, and the readable medium may send, propagate, or transmit programs for use by or in connection with a periodic network action system, apparatus, or device.

The program codes included in the readable medium may be transmitted by using any appropriate medium, including but not limited to wireless, wired, optical fiber cable, RF, etc., or any suitable combination of the foregoing.

The program codes for carrying out operations of the present disclosure may be written in any combination of one or more programming languages, including object-oriented programming languages such as Java, C++ and the like, as well as conventional procedural programming design languages, such as “C” language or similar programming languages. The program codes may be executed entirely on a user computing device, executed partly on the user equipment, executed as a stand-alone software package, executed partly on the user computing device and partly on a remote computing device or entirely executed on the remote computing device or a server. In the context of a remote computing device, the remote computing device may be connected to a user computing device through any type of network, including a local area network (LAN) or a wide area network (WAN) or may be connected to an external computing device.

The processing method for remote assistance according to the embodiment of the present disclosure further provides a machine readable non-transitory storage medium, that is, the content is not lost after the power is turned off. The storage medium stores a software program, including program codes. When the program codes run on computing equipment, the software program may be read and executed by one or more processors to implement a solution for debugging any of the above devices in the embodiments of the present disclosure.

The processing method for remote assistance according to the embodiment of the present disclosure further provides a machine readable non-transitory storage medium, that is, the content is not lost after the power is turned off. The storage medium stores a software program, including program codes. When the program codes run on computing equipment, the software program may be read and executed by one or more processors to implement a solution of any of the processing methods for remote assistance according to the embodiments of the present disclosure.

According to the processing method and apparatus above according to the embodiment of the present disclosure, after receiving a startup instruction, a client sends a request for a verification code to a server; the server randomly generates and returns the verification code to the client; and the client generates and stores a check code according to the verification code and a random code generated locally after receiving the startup instruction. Since the check code generated by the client is generated according to the verification code randomly generated by the server and the random code randomly generated at the local, the uniqueness of the check code is ensured.

The disclosure has been described in a block diagram and/or a flow chart of the method, the device (system) and/or the computer program product according to the embodiments of the disclosure. It shall be appreciated that respective blocks and/or flows in the block diagram and/or the flow chart and combinations of the blocks and/or the flows in the block diagram and/or the flow chart can be embodied in computer program instructions. These computer program instructions can be loaded onto a processor of a general-purpose computer, a specific-purpose computer, and/or other programmable data processing apparatuses to produce a machine so that the instructions executed on the computer processor and/or other programmable data processing apparatuses create means for performing the functions specified in the block(s) of the block diagram and/or the flow(s) of the flow chart.

Accordingly, this application may also be implemented in hardware and/or software (including firmware, resident software, microcode, etc.). Further, this application may take the form of a computer program product on a computer-usable or computer-readable storage medium, and the product includes computer-usable or computer-readable program codes implemented in a medium so as to be used by an instruction execution system or used in conjunction with an instruction execution system. In the context of the present application, a computer-usable or computer-readable medium may be any medium that can contain, store, communicate, transfer, or transmit the program for use by an instruction execution system, apparatus, or device, or used in conjunction with an instruction execution system, apparatus or device.

Evidently those skilled in the art can make various modifications and variations to the disclosure without departing from the spirit and scope of the disclosure. Thus the disclosure is also intended to encompass these modifications and variations thereto so long as the modifications and variations come into the scope of the claims appended to the disclosure and their equivalents.

1. A processing method for remote assistance, comprising:
receiving, by a server, a request from a client for a verification code;
generating, by the server, the verification code according to the request; and
returning, by the server, the verification code to the client such that the client combines the verification code with a random code generated locally by the client to generate a check code to be displayed to a user.

2. The method according to claim 1, further comprising:
receiving and storing, by the server, registration information from the client, wherein the registration information comprises the verification code and an identity of a device on which the client is running.

3. The method according to claim 2, further comprising:
receiving, by the server, an access request from a second application, wherein the access request comprises the check code generated by the client and obtained by a predetermined means, and the check code comprises the verification code and the random code generated locally by the client;
determining, by the server, the identity of the device according to the check code in the access request and the registration information;
sending, by the server, a request for access authentication to the client corresponding to the identity of the device, wherein the request for access authentication at least comprises the random code in the check code; and
sending, by the server, a successful connection status to the second application after receiving access authentication acknowledgement returned by the client.

4. The method according to claim 3, further comprising:
receiving, by the server, an instruction from the second application, wherein the instruction is used to instruct the client to execute a predetermined operation;
adding, by the server, at least the random code in the check code to the instruction and then sending the instruction to the client; and
forwarding, by the server, an execution result of the instruction to the second application after receiving the execution result returned by the client.

5. A processing method for remote assistance, comprising:
sending, by a client, a request for a verification code to a server after receiving a startup instruction;
receiving, by the client, the verification code returned by the server; and
generating and storing, by the client, a check code according to the verification code and a random code generated locally by the client after receiving the startup instruction.

6. The method according to claim 5, further comprising:
sending, by the client, registration information to the server, wherein the registration information comprises the verification code and an identity of a device on which the client is running.

7. The method according to claim 6, wherein after the client receives the startup instruction, the method further comprises:
generating, by the client, the random code locally.

8. The method according to claim 5,
further comprising:
displaying the check code according to a predetermined display form.

9. The method according to claim 8, further comprising:
receiving, by the client, a request for access authentication from the server, wherein the request for access authentication at least comprises the random code in the check code;
verifying, by the client, at least the random code included in the request for access authentication according to the check code stored locally by the client; and
returning, by the client, access authentication acknowledgement to the server after verifying successfully.

10. The method according to claim 9, further comprising:
receiving, by the client, an instruction which at least carries the random code, sending from the server, wherein the instruction is used to instruct the client to execute a predetermined operation;
verifying, by the client, at least the random code included in the instruction according to the check code stored locally by the client; and
executing, by the client, the instruction and returning an execution result of the instruction to the server after verifying successfully.

11. A server, comprising a memory and a processor, wherein the memory stores a computer program, and execution of the computer program by the processor causes the processor to:
receive a request from a client for a verification code;
generate the verification code according to the request; and
return the verification code to the client such that the client combines the verification code with a random code generated locally by the client to generate a check code to be displayed to a user.

12. The server according to claim 11, wherein the execution of the computer program by the processor further causes the processor to:
receive and store registration information from the client, wherein the registration information comprises the verification code and an identity of a device on which the client is running.

13. The server according to claim 12, wherein the execution of the computer program by the processor further causes the processor to:
receive an access request from a second application, wherein the access request comprises the check code generated by the client and obtained by a predetermined means, and the check code comprises the verification code and the random code generated locally by the client;
determine the identity of the device according to the check code in the access request and the registration information;
send a request for access authentication to the client corresponding to the identity of the device, wherein the request for access authentication at least comprises the random code in the check code; and
send a successful connection status to the second application after receiving access authentication acknowledgement returned by the client.

14. The server according to claim 13, wherein the execution of the computer program by the processor further causes the processor to:
receive an instruction from the second application, wherein the instruction is used to instruct the client to execute a predetermined operation;
add at least the random code in the check code to the instruction and then send the instruction to the client; and
forward an execution result of the instruction to the second application after receiving the execution result returned by the client.

15. (canceled)

16. (canceled)
